(19) United States
(12) Patent Application Publication
(10) Pub. No.: US 2018/0202305 A1
(43) Pub. Date: Jul. 19, 2018

(54) RING SEGMENT WITH DIFFERENT RADII

(71) Applicant: Siemens Aktiengesellschaft, Munich (DE)

(72) Inventors: Rex Smith, Berlin (DE); Ronald Balliram, West Palm Beach, FL (US); Robert Hudson, Jupiter, FL (US)

(73) Assignee: Siemens Aktiengesellschaft, Munich (DE)

(21) Appl. No.: 15/742,798

(22) PCT Filed: Jul. 15, 2016
(86) PCT No.: PCT/EP2016/066921

§ 371 Date: Jan. 8, 2018

(30) Foreign Application Priority Data
Jul. 15, 2015 (EP) 15176826.4

(51) Int. Cl. F01D 11/12; F01D 25/24

(52) U.S. Cl. CPC F01D 11/12; F01D 25/246; F05D 2260/201; F05D 2250/71; F05D 2240/11

(57) ABSTRACT

A ring segment for a gas turbine has a base body having a first surface subjectable to hot gas, second surface arranged opposite of the first surface and fastening elements extending from the second surface. The ring segment extends in the axial direction and in an azimuthal direction of the gas turbine. The first and second surfaces are curved in the azimuthal direction and straight along the axial direction. The fastening elements have at least two rows of hooks, each extends in the azimuthal direction, wherein each hook has an outwardly directed surface and an inwardly directed surface which are curved in the second direction. At the outer sections of the ring segment the distances (R3) are smaller than that (R4) in the middle section. The distances (R5, R6) between the outwardly directed surfaces of the corresponding row of hooks and the machine axis is constant along the azimuthal direction.

### CROSS REFERENCE TO RELATED APPLICATIONS

This application is the US National Stage of International Application No. PCT/EP2016/066921 filed Jul. 15, 2016, and claims the benefit thereof. The International Application claims the benefit of European Application No. EP15176826 filed Jul. 15, 2015. All of the applications are incorporated by reference herein in their entirety.

### FIELD OF INVENTION

The invention relates to a ring segment for a gas turbine, comprising a base body having a first surface subjectable to a hot gas and a second surface which is arranged opposite of the first surface and fastening elements extending from the second surface, the ring segment extends in the first direction which corresponds with the axial direction of a gas turbine when the ring segment is assembled therein and in a second direction which corresponds with the azimuthal direction of said gas turbine when the ring segment is assembled there-in, said first and second surfaces are curved in the second direction and straight along the first direction, wherein said fastening elements comprise at least two rows of hooks, each row extends in the second direction and wherein each hook comprises an outwardly directed surface and an inwardly directed surface with regard to a machine axis of said gas turbine, when the ring segment is assembled therein, said surfaces in the second direction.

### BACKGROUND OF INVENTION

The before mentioned coolable wall elements are well known as ring segments in the prior art. These ring segments, also known as blade outer air seals, are usually arranged within the gas turbine for bordering the hot gas path of a turbine section. These ring segments are arranged along the circumferential direction whereby all segments of a circumference create a ring. Inside of said ring, turbine blades mounted on the rotor of the turbine moves along their hot gas path surface when said turbine rotor is rotating during operation.

Usually said ring segments are carried by a turbine vane carrier. Usual turbine vane carriers are in cross section perpendicular to the machine axis in annular shape and for stationary gas turbines split into a lower half and an upper half. The turbine vane carrier has annular grooves extending in the circumferential direction in which the ring segments could be slid to their dedicated position one by one to form outer border of the hot gas path.

To provide a concentric hot gas path surface of the ring segment the ring segment has to be hold from the turbine vane carrier in a fixed position without significant motion.

Due to the hot gas flowing along the ring segments, said ring segments have to be cooled to reach their predetermined life time and to avoid any thermal displacements. For cooling purposes it is known to attach an impingement plate on the outer side of the ring segments in such a way, that the ring segment could be cooled by air impinging on the cold side of the ring segment thereby carrying away the thermal energy of the wall of the ring segment.

During operation of the gas turbine comprising the above mentioned ring segments said ring segments are subjected to the hot gas of the gas turbine. The thermal influence of the hot gas leads to internal stress and tension. Both stress and tension leading to a deformation of the ring segment, which results in an uneven and uncontrolled tip gapping to a rotor blade, which passes along the first surfaces. Further, during the life of the ring segment, the rotor blade tip gap varies also.

In the past blade tip gapping had to be large to account for the ring segment from a displacement relative to the blade tip. The blade tip to ring segment gaps were larger than desired resulting in lower engine performance since the hot gas circumvent the airfoil without transforming its thermal energy into mechanical energy.

To counteract this it is known from US 2009/0180863 A1 that ring segments have in rest configuration in which the turbine is not operating, an eccentric hot surface with respect to the turbine axis and in an operating configuration in which the turbine is operating under regime conditions a centered hot surface. In detail leads this to reduced tip clearances during operation. However, these ring segments are hard to design due to many unknown boundary conditions.

Beside this US 2010/0247298 A1 discloses a turbine shroud having a forward rail-shaped hook and an aft rail-shaped hook on its cold side for assembling it into respective grooves of a turbine vane carrier. To allow the turbine shroud to bend due to thermal influence caused by operation, each hook has different clearances between their outer and inner surfaces on the one hand and their respective corresponding surfaces of said grooves on the other hand and with respect to the circumferential extension of the rail-shaped hooks. However, the proposed hook design is complex and expensive to manufacture.

### SUMMARY OF INVENTION

An object of the present invention is to provide a ring segment, which assembled in a gas turbine and operated therein enables smaller tip gapping between the tips of rotor blades and the opposite arranged surface of a ring segment for the whole life time of the ring segment.

This problem is solved with a ring segment according to the independent claim.

The proposed design of both the first surface of the base body and the inwardly and outwardly directed surfaces of the respective hooks according to the invention leads to an improved attachment of the hooks in the concentrically grooves of the turbine vane carrier. When mounted in a conventional carrier the ring segment leads to different clearances in only the more inward located surfaces of the groove-hook-paired surfaces and a constant loose clearance in the more outward located surfaces of the groove-hook-paired surfaces. In other words: the distances between the outwardly directed surfaces of the hooks of the corresponding row and the machine axis is constant along the second direction. This reduces wear as well as the effect of creep deformation of the ring segment over the blade tip. Hence with these proposals a well gap is provided for selected but not all hooks of a dedicated row so that the ring segment is better able to extend thermally. In other words some hooks of a single row have a smaller clearance within their groove than other hooks of the same row. Since the local thermal grow of the ring segment is different for different locations along its extension in circumference direction, the first surface of the base body has to be adapted so that in hot condition the first surface in the second direction is concentrically.

This behavior leads to an improved tip gapping so that said tip gaps could be constructed smaller than in the conventional gas turbine. Smaller tip gaps reduce the hot gas leakages over the tip gap hence improving the efficiency of the transformation of energy while simultaneously the lifetime of the ring segment is extended.

Further the ring segment is assembled in the gas turbine said inwardly directed surfaces of the hooks are located on said row of hooks, which is arranged at the forward side of the ring segment, with regard to the hot gas streaming direction. Said hook configuration presents a more uniform or balanced load between the hooks, as the ring segment “uncurls” from operational thermal loading (hot gas path side vs. cold side).

Additionally the respective row of hooks having the inwardly directed surfaces with different distances to the machine axis comprises at least three hooks.

Further embodiments are mentioned in the depending claims, wherein their features could be combined in any combination.

Advantageously the difference between the different radii is about a size smaller than two millimeters. Further the difference between the different radii advantageously has a size of 0.7 millimeters, especially, when the ring segment is designated to be used in heavy duty gas turbine.

### BRIEF DESCRIPTION OF THE DRAWINGS

The invention will be explained in the following description accompanied by the drawings.

FIG. 1 shows an example of ring segment in a perspective view onto the cold surface of said ring segment and

FIG. 2 shows the front view along the axial direction of a gas turbine onto said ring segment.

### DETAILED DESCRIPTION OF INVENTION

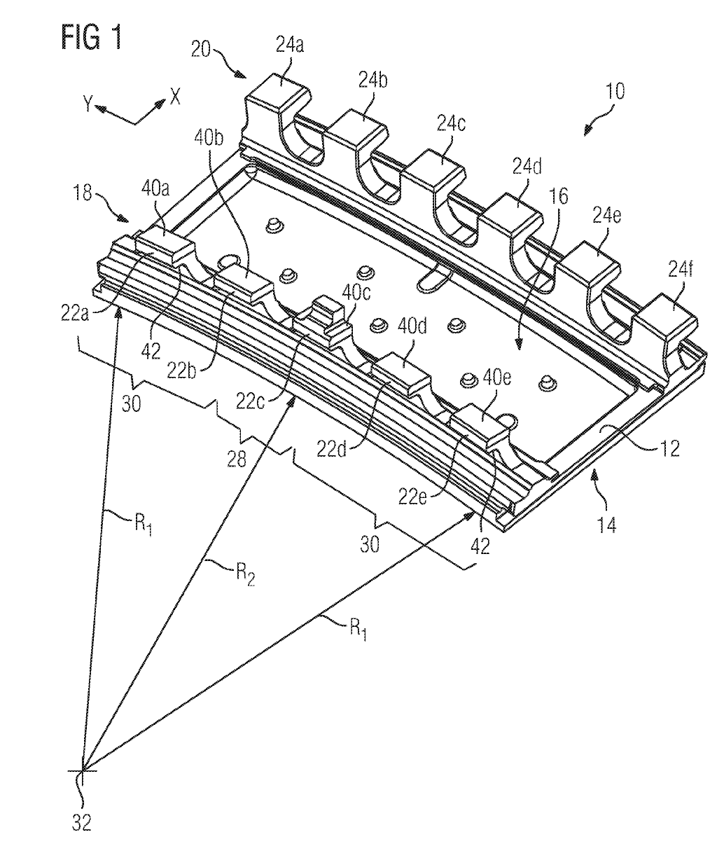

A ring segment 10 is shown in FIG. 1 in a perspective view. The ring segment 10 comprises a base body 12 having a first surface 14 subjectable to a hot gas and a second surface 16 which is arranged opposite of the first surface 14. Fastening elements in form of two rows 18, 20 of hooks 22, 24 are located on the second surface 16 of the base body 12. The first row 18 comprises five hooks 22 while the second row 20 comprises six hooks 24.

The individual hooks 22, 24 will be named in the following description by adding suffixes a-e to the reference numbers 22 or a-f the reference numbers 24.

When assembled the ring segment 10 in a turbine vane carrier of a gas turbine, the ring segment 10 extends in the first direction X which corresponds with the axial direction of said gas turbine. When assembled the ring segment 10 in a turbine vane carrier of a gas turbine, the ring segment 10 extends perpendicular to the first direction X in a second direction Y which corresponds with the azimuthal direction of said gas turbine.

The first surface 14 is curved with regard to the second direction Y. With regard to the first direction X, the first surface is straight, but inclined.

Only logically and along the azimuthal direction the first surface 14 and the ring segment 10 could be divided into three different sections. These sections comprise a middle section 28 and two outer sections 30. Each of the different sections 28, 30 has its individual distance with regard to a machine axis 32 of a gas turbine when the ring segment 10 is assembled in said gas turbine. The two outer sections 30 comprise a first distance R1, while the middle section 28 comprises a distance R2. The distance R1 differs only slightly from R2. It is preferred that the distance R1 is smaller about a size of approximately one millimeter than the distance R2, but not smaller than 0.5 mm. An appropriate value for the difference is 0.7 mm.

As displayed in the drawing of FIG. 1, the two outer sections 30 having a size in the second direction Y so that each section comprises two hooks 22 of the first row 18: 22a, 22b and 22d, 22e. In the middle section 28 only hook 22c is located. This is only an exemplary embodiment. It is also possible that only one single hook 22a and 22e are located in the outer sections 30 while the middle section comprises three hooks 22b, 22c, 22d when the row 18 still comprises five hooks 22 in total. Other number of the hooks per row is also possible.

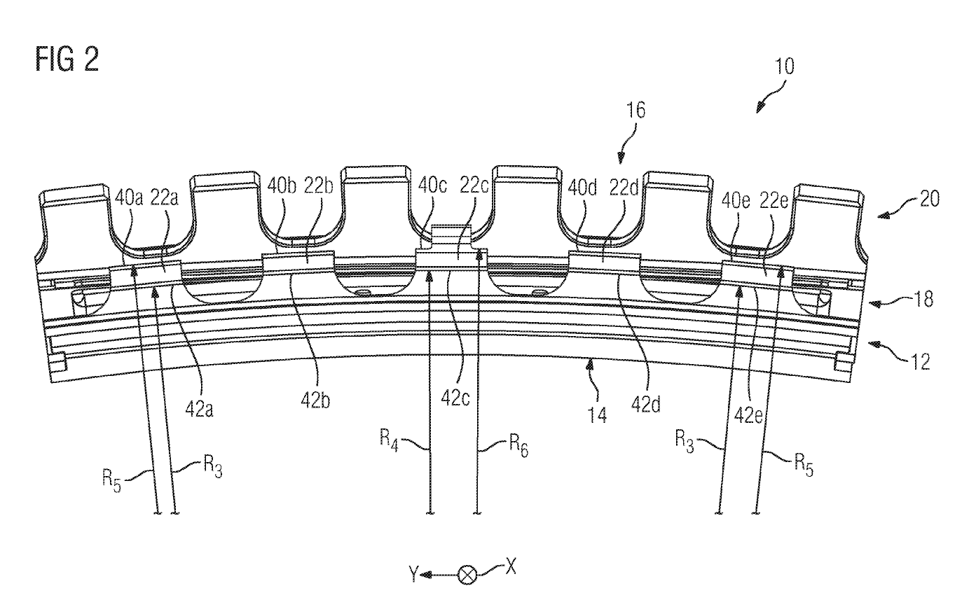

FIG. 2 shows the front view onto the ring segment of FIG. 1. Each of the first hooks 22 comprises an outwardly directed surface 40 and an inwardly directed surface 42. All of these surfaces 40, 42 are curved in the second direction Y. However, the curvature of the different surfaces 40, 42 and for different hooks 22a-22e could be adapted accordingly as for the first surface 14 in an analogous way:

At least the two outer hooks 22a and 22e comprise an identical distance R3 for their inwardly directed surfaces 42a, 42e. The inwardly directed surface 42c of the middle hook 22c has a curvature with a distance R4. This distance R4 and also the other distances mentioned herein refer each time to the machine axis, which in FIG. 2 is not displayed. According to the invention, these radii R3, R4 could differ slightly. The difference between R3 and R4 should be approximately equal to the difference between R1 and R2.

Contrary to this, the outwardly directed surfaces 40a, 40e of the outer hooks 22a and 22e comprise a distance R5 with regard to the machine axis being identical with a distance R6, wherein the distance R6 represents the distance between the outwardly directed surface 40 of the middle hook 22c to the machine axis.

Having different distances for either different sections of the first surface 14 and for the inwardly directed surfaces 42 of the hooks 22 the different distances occur in cold condition leading to a non-circular design of the hooks 22 of a dedicated row respectively of the first surface 14. In operation of a gas turbine and under hot conditions the ring segment 10 tends to uncurl and to straighten itself which is slightly possible due to the different clearances of the individual hooks of a row resulting in a first surface 40, which is in azimuthal direction concentrically. Then the first surface 14 is conically.

Alternatively or additionally, the hooks 24 of the row 20 can be designed in an analogous manner.

1-4. (canceled)

5. A ring segment for a gas turbine, comprising:
a base body having a first surface subjectable to a hot gas,
a second surface which is arranged opposite of the first surface, and
fastening elements extending from the second surface,
wherein the ring segment extends in a first direction (X) which corresponds with the axial direction of a gas turbine when the ring segment is assembled in a gas turbine and in a second direction (Y) which corresponds with the azimuthal direction of a gas turbine when the ring segment is assembled in a gas turbine,
wherein said first and second surfaces are curved in the second direction (Y) and straight along the first direction (X),
wherein said fastening elements comprise at least two rows of hooks, each hook row extends in the second direction (Y),
wherein, when the ring segment is assembled in a carrier of the gas turbine, each hook comprises an outwardly directed surface and an inwardly directed surface with respect to a machine axis of said gas turbine, which are curved in the second direction (Y),
wherein the ring segment along the second direction (Y) comprises a middle section between two outer sections,
wherein distances (R1, R2) between the first surface and said machine axis differs along the second direction (Y) such that at the outer sections of the ring segment the distances (R1) are smaller than the distance (R2) in the middle section,
wherein when the ring segment is assembled in a gas turbine, said inwardly directed surfaces are located on hooks of a first row, which is arranged at the forward side of the ring segment, the first row having the inwardly directed surfaces with different distances (R3, R4) to the machine axis comprises at least three hooks,
wherein the distances (R3, R4) between the inwardly directed surfaces of hooks of at least one of the rows and the machine axis differs along the second direction (Y) such that at the outer sections of the ring segment the distances (R3) are smaller than the distance (R4) in the middle section, and
wherein the distances (R5, R6) between the outwardly directed surfaces of hooks of the corresponding row and the machine axis are constant along the second direction (Y).

6. The ring segment according to claim 5,
wherein differences between the different distances (R1, R2) is smaller than 2.0 mm and not smaller than 0.5 mm.

7. The ring segment according to claim 5,
wherein differences between the different distances (R3, R4) is smaller than 2.0 mm and not smaller than 0.5 mm.
